(19) United States
(12) Patent Application Publication
(10) Pub. No.: US 2009/0052821 A1
(43) Pub. Date: Feb. 26, 2009

(54) METHOD OF SUPPORTING A SHAFT ON BEARINGS AND BEARING ARRANGEMENT

(75) Inventor: Werner Hartmann, Vaihingen/Enz (DE)

Correspondence Address: OSHA LIANG L.L.P., TWO HOUSTON CENTER, 909 FANNIN, SUITE 3500, HOUSTON, TX, 77010, US

(73) Assignee: Valeo Wischersysteme GmbH, Bietigheim-Bissingen (DE)

(21) Appl. No.: 11/912,491

(22) PCT Filed: Apr. 20, 2006
(86) PCT No.: PCT/EP2006/003627

§ 371 Date: May 6, 2008

(30) Foreign Application Priority Data
Apr. 27, 2005 (DE) 10 2005 019 501.6

(51) Int. Cl. F16C 33/04; B23P 11/00

(52) U.S. Cl. 384/295; 29/525; 384/276

(57) ABSTRACT

A bearing arrangement for an output shaft of a gear of an electromotive windscreen wiper drive has the output shaft and an eccentric grommet configured to align the output shaft with at least one further gear element by rotation around an grommet axis. The eccentric grommet is anchored by being pressed into a receiving opening of a bearing housing for a press-fit. The eccentric grommet a has no flange.

The invention relates to a method of supporting a shaft on bearings, for example the output shaft of a gear of an electromotive accessory drive for vehicles, e.g. an electromotive windscreen wiper drive according to the generic term of patient claim 1 in addition to a bearing arrangement according to the generic term of patent claim 14.

Known is a bearing arrangement for the output shaft of an electromotive accessory drive for vehicles, i.e. for the output shaft of a worm wheel gear of a windscreen wiper drive (BE 44 19 769 A1). In order to align the axis of the output shaft or a worm wheel provided on the output shaft in relation to the axis of another gear element, i.e. in relation to the worm of the worm wheel gear, the bearing arrangement is essentially formed of an eccentric grommet, which has a bearing drilling in order to support the output shaft and which is held in a receiving opening of a bearing housing or gear housing section by press fitting. Alignment is performed by rotating the eccentric grommet in the receiving opening of the housing section. In order to ensure a predetermined stop position of the eccentric grommet in the receiving opening of the housing section during production, the eccentric grommet has a projecting flange on one end, which lies against the inside surface of the housing section. The known bearing arrangement is relatively elaborate if only owing to the additional flange on the eccentric grommet. Another disadvantage however is also that alignment of the output shaft or the worm wheel provided on this shaft in relation to the further gear element (worm) acting in conjunction with the worm wheel is only possible with the eccentric grommet already completely inserted into the receiving opening in the housing section, i.e. a considerable torque is necessary in order to rotate the eccentric grommet during alignment.

Known also is a method for aligned support on bearings of an output shaft of a worm gear of an electromotive windscreen wiper drive (WO 94/05533) in which (method), after aligning the shaft, an annular gap formed between the latter and a bearing body is injected with plastic material, which once hardened, forms the bearing grommet for the shaft.

Furthermore, a bearing arrangement for the output shaft of a worm wheel gear of an electromotive accessory drive for vehicles is also known (DE 22 41 221 A1) in which an eccentric grommet serves in turn as the bearing grommet for the shaft, which is provided as a rotatable component in the receiving opening of a housing section for alignment of the output shaft and the worm wheel provided on the latter and which is secured after alignment by a cap-like locking member against further rotation. This design is also elaborate.

The purpose of the invention is to demonstrate a method for supporting on bearings a shaft of a gear for an electromotive accessory drive, particularly for supporting an output shaft of such a gear, which (method) is realisable using cheap components and allows simple alignment of the shaft. In order to perform this task, a method according to patent claim 1 is developed. A bearing arrangement is the subject of patent claim 14.

Further developments of the invention are the subject of the subclaims. The invention will be described in more detail below based on the figures in various different examples of embodiment.

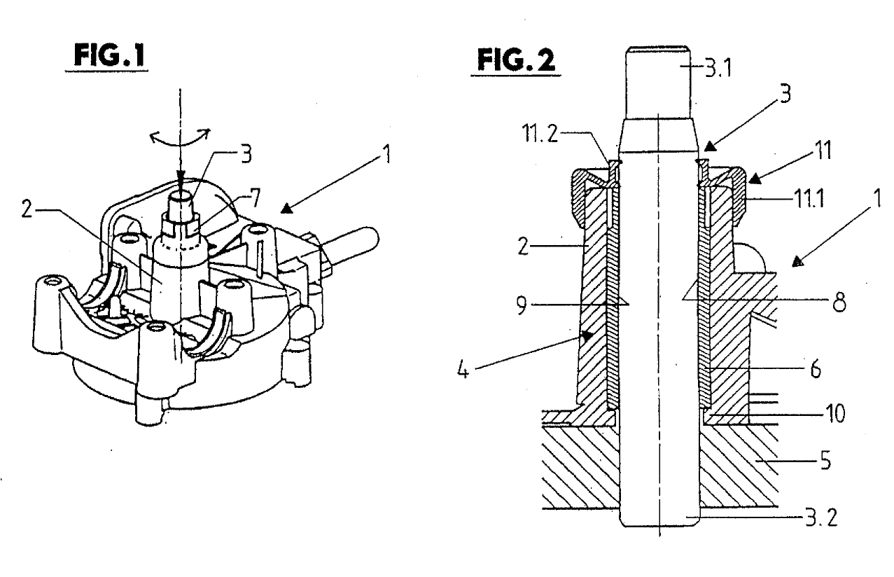

FIG. 1 shows in perspective presentation a housing section of a gear housing of an electromotive accessory drive, in the form of a windscreen wiper drive, together with an output shaft supported in the housing section and in a bearing housing designed there;

FIG. 2 shows an enlarged presentation of a partial section through the gear housing in the area of the bearing arrangement for the output shaft;

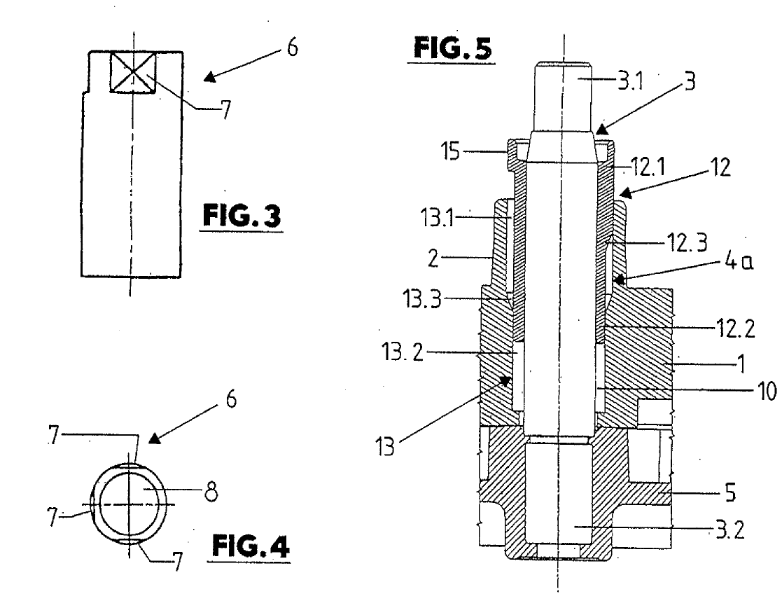

FIGS. 3 and 4 show a bearing and eccentric grommet for supporting the output shaft in a side view and a top view;

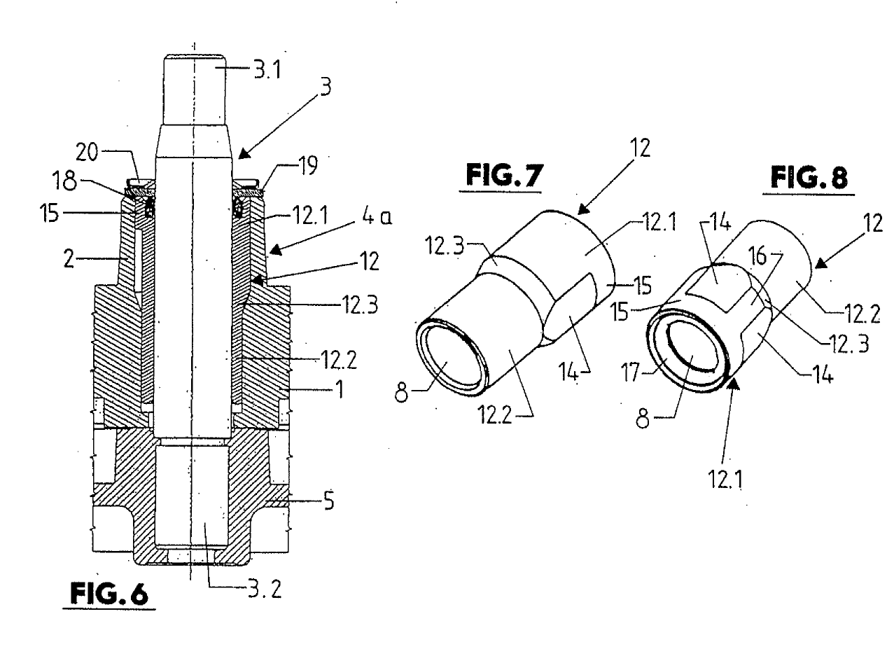

FIGS. 5 and 6 show presentations similar to FIG. 2 during alignment of the output shaft with the eccentric bearing socket and after final fixing of the bearing socket in the housing section;

FIGS. 7 and 8 show a perspective view and different views respectively of the eccentric grommet of the bearing arrangement of FIGS. 5 and 6;

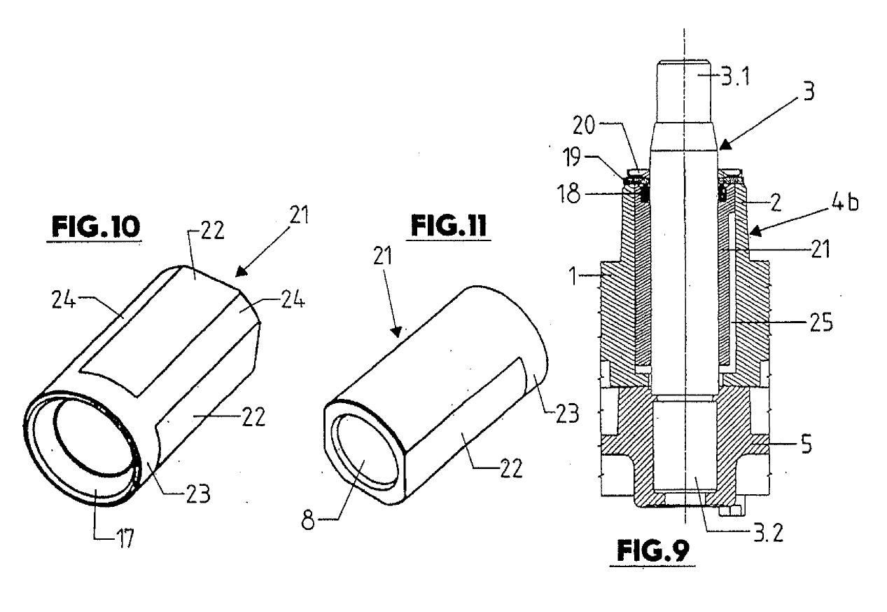

FIG. 9 shows a presentation similar to FIG. 2 with a further possible embodiment;

FIGS. 10 and 11 show a perspective presentation and different views of the eccentric grommet of the bearing arrangement in FIG. 9.

In the figures, 1 is a housing section of the gear housing of a worm gear of an electromotive accessory drive for vehicles, i.e. a windscreen wiper drive, for example manufactured from injection-moulded metal. In the housing section 1 or in a shaped, hollow-pin-like bearing housing or section 2 projecting over the upper outer side of the housing section 1 in FIG. 1 is an output shaft 3 which is rotatably supported by means of a bearing arrangement 4 and indeed in such a manner that the output shaft 3 projects with a section 3.1 from the gear housing and indeed for a driving link with further functional elements of a wiper module. The other end 3.2 of the output shaft bears a gear or worm wheel 5 inside the gear housing.

The bearing arrangement 4 is formed by a bearing and eccentric socket or grommet 9, which is provided with three flat surface sections and tool gripping surfaces 7 on the end facing away from the gear wheel 5 on its cylindrical outer or circumferential surface, the levels of which are oriented parallel to the grommet axis (axis of the cylindrical outer surface) and are provided offset by 90° against each other around this axis. The eccentric grommet 6 is provided with a bearing drilling 8 for the shaft, the axis of which, although oriented parallel to the grommet axis, is somewhat eccentrically displaced in relation to the latter.

In the assembled condition, the eccentric grommet 6 is held in an adapted, i.e. cylindrical drilling or receiving opening 9 of the housing section 2 by press-fitting. The press-fit between the outer surface of the bearing grommet 6 and the inside surface of the receiving opening 9 is chosen such that joint rotation of the eccentric grommet 6 with the output shaft 3 is definitely prevented.

As can furthermore be seen from FIG. 2, the eccentric grommet in the installed condition is taken up over its entire length by the receiving opening 9 and indeed in such a way that it rests with its end facing the gear wheel 5 on a flange or recess 10, which is designed in such a way that the receiving opening 9 on the end facing the gear wheel 5 and therefore the inside of the gear housing has a section with a reduced diameter, which is nevertheless larger than the outer diameter of the output shaft 3.

A sealing cap 11 made of a suitable elastic material, for example of a suitable elastic rubber material, is applied to the free end of section 2 overlapping the free end of section 2 with an outer cap wheel 11.1 and lies with an inside edge 11.2 and with two ring-shaped sealing lips offset in the axis direction of the output shaft 3 against the outer surface of the output shaft 3 and consequently seals the bearing arrangement 4 in the outwards direction.

Installation is performed in such a way that with initially only a partial length, e.g. with approximately half the length or approximately two thirds of the entire length of the eccentric grommet 6 inserted in the receiving opening 9 and with the output shaft 3 already mounted in this eccentric grommet 6 with the gear wheel 5 mounted on this shaft by rotating the eccentric grommet 6 around its axis, alignment of the axis of the output shaft 3 and therefore the gear wheel 5 in relation to the axis of a further shaft, for example in relation to the axis of the worm on the armature shaft of the electric motor interacting with the gear wheel, and which is not illustrated, is performed in such a way that the desired meshing between the gear wheel 5 and the worm or another gear element is achieved. Subsequently, the eccentric grommet 6 is pressed into the receiving opening 9 with a suitable tool until it lies with its bottom face in FIG. 2 against the rim 10 and is held in the receiving opening 9 by press-fitting. The sealing cap 11 is applied in a subsequent working stage.

The bearing arrangement 4 allows simple and rapid alignment of the axis of the output shaft 3 and indeed with a cheap and extremely compact construction. In particular, the eccentric grommet 6 is also simple and cheap to manufacture without a flange. Nevertheless, a definite axial position of the eccentric grommet 6 is guaranteed after pressing into the receiving opening 9 thanks to the rim 10.

As a deviation from the above embodiments, it is also possible to design the eccentric grommet 8 with a slightly truncated cone shape on its outside surface 7 and indeed in such a way that its external diameter to the end having the tool gripping surfaces slightly increases, so that the eccentric grommet 6 only inserted with a partial length into the receiving opening 9 during alignment of the axis of the output shaft 3 can be particularly easily rotated, after pressing in or push-fitting in the receiving opening 9 and held by press-fitting.

FIGS. 5-8 show a bearing arrangement 4a as another possible embodiment, which differs from the bearing arrangement 4 by a bearing or eccentric socket or grommet 12 different from the eccentric grommet 6 and a drilling or receiving opening 13 adapted to the eccentric grommet 12 in section 2.

The eccentric grommet 12, which in turn forms the bearing drilling 8 for the output shaft 3 is essentially composed of three sections, which follow each other in the direction of the grommet axis and are arranged in the same axis with one another, and indeed of section 12.1 with the larger cylindrical outer diameter, which forms the outside upper end of the eccentric grommet 12 in FIGS. 5 and 6, of section 12.2 with a reduced cylindrical outer diameter, which forms the inside lower end of the eccentric grommet 12 in FIGS. 5 and 6 and of a section 12.3, which forms the transition between sections 12.1 and 12.2 and which increases the external diameter of the eccentric grommet cylindrically from section 12.2 to section 12.1. The axis of the bearing drilling 8 is in turn parallel to the grommet axis, but somewhat radially offset in relation to the latter. On section 12.1, the eccentric grommet 12 has three flat tool gripping surfaces 14, which in turn lie in planes parallel to the axis of the eccentric grommet 12 and are provided 90° offset against each other at the circumference of the eccentric grommet 12. As FIGS. 7 and 8 also show, the tool gripping surfaces 14 also extend into section 12.3 and are designed in the embodiment presented in such a manner that they respectively lie at an interval from the grommet axis which is equivalent to the half external diameter of section 12.2.

The receiving opening 13 is adapted to the external diameter of the eccentric grommet 12, i.e. it has three sections which are adjacent to one another in the axis direction of the receiving opening 13, i.e. the upper outside cylindrical section 13.1 with the larger diameter, the lower cylindrical section 13.2 in FIGS. 5 and 6 with the smaller diameter and the truncated cone section 13.3 which forms the transition between sections 13.1 and 13.2.

The tool gripping surfaces 14 end respectively at a distance from the free end of section 12.1 so that at the end, the outer surface of section 12.1 forms a cylindrical ring-shaped edge area 15 which is not interrupted by the tool gripping surfaces. Furthermore, the tool gripping surfaces are designed in such a way that a bridge 16 remains respectively between two consecutive tool gripping surfaces 14 in the direction of the circumference.

During installation, the eccentric grommet 12 is inserted with a partial length and in the embodiment presented with approximately two thirds of its entire length, into the receiving opening 13, so that the eccentric grommet 12 is precisely aligned in the receiving opening 13 and the output shaft 3 is received in the eccentric grommet 12 or in the bearing drilling 8 there. The eccentric grommet 12 is received in this case with a partial length of its section 12.1 in section 13.1 and with a partial length of its section 12.2 in section 13.2 of the receiving opening 13. Section 12.1 projects from section 13.1 to such an extent that the tool gripping surfaces are accessible to a tool. By rotating the eccentric grommet 12, the output shaft 3 and therefore the gear wheel is aligned in relation to another gear element. Once alignment has been performed successfully, the eccentric grommet 12 is axially pressed into the receiving opening 13 using a suitable pressing tool, so that it is retained there by press-fitting.

After pressing the eccentric grommet 12 into the receiving opening 13, a sealing ring 18 surrounding the output shaft 3 is inserted into a groove-shaped extension 17, which has the bearing drilling 8 at the end of section 12.1 and which is open to this end and radially inwards and the sealing ring is subsequently secured by a washer 19 applied to the output shaft 3 and a securing ring 20 axially securing this washer (e.g. retaining ring).

FIGS. 9-11 show a bearing arrangement 4b as a further possible embodiment, which essentially differs from the bearing arrangement 4a in that instead of the eccentric grommet 12, a bearing and eccentric socket or grommet 21 is used which in turn has the bearing drilling 8 for the output shaft 3, but which is designed cylindrically on its outer surface over its entire length, that is to say with three incorporated flat tool gripping surfaces 22, the planes of which lie parallel to the grommet axis of the eccentric grommet 21 and which are provided 90° offset against each other around the grommet axis.

As FIGS. 10 and 11 show, the tool gripping surfaces 22 extend respectively in this embodiment to the inner end of the eccentric grommet 21, but end however at a distance from the outer end, so that a peripheral area 15 corresponding to the peripheral area 23 results on which the outer surface of the eccentric grommet 23 is executed in a cylinder shape throughout. Between two tool gripping surfaces in succession in the circumferential direction, a bridge 16 corresponding to the bridge 24 is furthermore formed. At the end allocated to the peripheral area 23, the bearing drilling 8 in turn has the extension 17 for the sealing ring 18.

The drilling corresponding to the receiving opening 13 or receiving opening 25 is designed with a cylindrical shape in bearing arrangement 4b. For alignment of the axis of the output shaft 3, the eccentric grommet 21 is again only inserted with a part of its length into the receiving opening 25. Alignment is performed by rotating the eccentric grommet 21 with a tool engaging on the tool gripping surfaces 22. After alignment and pressing the eccentric grommet 21 into the receiving opening 25, the extension 17 of the sealing ring 18 is inserted and the latter is secured with the washer 19 and securing ring 20.

Owing to the peripheral areas 15 and 23, the receiving opening 13 and 25 is already sealed on the outer side of the housing section 1 after pressing the respective eccentric grommet 12 and 21.

The invention has been described above based on examples of embodiment. It is understood that many modifications in addition to variations are possible without abandoning the concept on which the invention is based.

### LIST OF REFERENCES

1 Housing section
2 Housing portion
3 Output shaft
3.1, 3.2 End of the output shaft 3
4, 4a, 4b Bearing arrangement
5 Gear wheel
6 Bearing and eccentric grommet
7 Tool gripping surface
8 Bearing drilling
9 Drilling or receiving opening in housing portion 2
10 Rim
11 Sealing cap
11.1 Outer edge
11.2 Inner edge
12 Bearing and eccentric grommet
12.1, 12.2 Cylindrical shaped section
12.3 Truncated cone shaped section
13 Drilling or receiving opening in housing portion 2
13.1, 13.2, 13.3 Opening section
14 Tool gripping surface
15 Peripheral area
16 Bridge
17 Extension of the bearing drilling
18 Sealing ring
19 Washer
20 Securing ring or retaining ring
21 Eccentric grommet
22 Tool gripping surface
23 Peripheral area
24 Bridge
25 Drilling or receiving opening

1. A method for supporting an output shaft of a gear of an electromotive windscreen wiper drive in a bearing housing comprising an eccentric grommet forming a bearing grommet for the output shaft the method comprising:
aligning the output shaft with at least a further gear element by rotating the eccentric bearing grommet inserted in a receiving opening of the bearing housing around a grommet axis, with only a partial length of the eccentric grommet inserted from a gear housing outer side into the receiving opening of the bearing housing and with the output shaft received in the eccentric grommet; and
pressing the eccentric grommet into the receiving opening for the press-fit.

2. The method according to claim 1, wherein alignment and rotation of the eccentric grommet is performed with a tool engaging on tool gripping surfaces provided on a partial length of the eccentric grommet projecting from the receiving opening.

3. The method according to claim 1 wherein the eccentric grommet is pressed into the receiving opening of the housing section such that it the eccentric grommet is taken up over an entire length in the receiving opening.

4. The method according to claim 1, wherein pressing the eccentric grommet into the receiving opening is limited by a stop formed in the receiving opening.

5. The method according to claim 1, further comprising: applying a cap-shaped seal surrounding the output shaft to an end of the output shaft projecting over the gear housing outer side.

6. The method according to claim 1, further comprising: applying at least one seal surrounding the output shaft and lying against the eccentric grommet into an annular gap formed in a bearing drilling of the eccentric grommet.

7. The method according to claim 1, wherein the eccentric grommet and the receiving opening are cylindrical and the eccentric grommet comprises on on an outer surface at a first end thereof at least two tool gripping surfaces.

8. The method according to claim 1, wherein
the eccentric grommet comprises first, second, and third grommet sections adjacent to one another in a direction on a grommet axis,
the first grommet section is at one end of the eccentric grommet and comprises a cylindrical outer surface
a second grommet section is at the other end of the eccentric grommet and comprises a cylindrical outer surface and has a smaller external diameter than the first grommet section , and
a third grommet section forms a transition between the first and second grommet sections,
an external diameter decreases from the first grommet section to the second grommet section, and
the receiving opening is adapted to a shape of the eccentric grommet and comprises:
a first opening section comprising a cylindrical inner surface,
a second opening section comprising a cylindrical inner surface having a smaller diameter than the first opening section, and
a third opening section connecting the first and second opening sections with a decreasing diameter from the first opening section to the second opening section.

9. The method according to claim 8, wherein aligning the output shaft comprises the eccentric grommet extending with a partial length of its first section into the first opening section and with a partial length of its second section into the second opening section.

10. The method according to claim 7, wherein the tool gripping surfaces only extend over a partial length of the eccentric grommet.

11. The method according to claim 7, wherein the tool gripping surfaces extend to a second end of the eccentric grommet.

12. (canceled)

13. The method according to claim 1, the eccentric grommet forms a continuous cylindrical shaped peripheral area on an outer area on an end projecting from a receiving opening during alignment.

14. A bearing arrangement for an output shaft of a gear of an electromotive windscreen wiper drive, comprising:
the output shaft; and
an eccentric grommet configured to align the output shaft with at least one further gear element by rotation around is an grommet axis, wherein
the eccentric grommet is anchored by being pressed into a receiving opening of a bearing housing for a press-fit, and
the eccentric grommet has no flange.

15. The bearing arrangement according to claim 14, wherein an entire length of the eccentric grommet is received in the receiving opening.

16. The bearing arrangement according to claim 14, wherein a stop limiting pressing of the eccentric grommet is formed in the receiving opening.

17. The bearing arrangement according to claim 14, wherein a cap-shaped seal surrounding the output shaft is applied on an end of the output shaft projecting over a gear housing outer side.

18. The bearing arrangement according to claim 14, wherein at least one seal surrounding the output shaft and lying against the eccentric grommet is applied in an annular gap formed in a bearing drilling of the eccentric grommet.

19. The bearing arrangement according to claim 14, wherein the eccentric grommet and the receiving opening are cylindrical, and the eccentric grommet comprises at least two tool gripping surfaces on an outer surface at a first end thereof.

20. The bearing arrangement according to claim 14, wherein
the eccentric grommet comprises first, second, and third grommet sections adjacent in a direction on a grommet axis
the first grommet section is at one end of the eccentric grommet and comprises a cylindrical outer surface,
the second grommet section is at the other end of the eccentric grommet and comprises a cylindrical shaped outer surface and has a smaller external diameter than the first grommet section,
the third grommet section forms a the transition between the first and second grommet section,
an external diameter decreases from the first grommet section to the second grommet section, and
the receiving opening is adapted to a shape of the eccentric grommet comprises:
a first opening section comprising a cylindrical inner surface,
a second opening section comprising a cylindrical inner surface having a smaller diameter than the first opening section, and
a third opening section connecting the first and second opening sections with a decreasing diameter from the first opening section to the second opening section.

21. The bearing arrangement according to claim 14, wherein the eccentric grommet has tool gripping surfaces for alignment and rotation on an outer surface thereof.

22. The bearing arrangement according to claim 19, wherein the tool gripping surfaces only extend over a partial length of the eccentric grommet.

23. The bearing arrangement according to claim 19, wherein the tool gripping surfaces extend to a second end of the eccentric grommet.

24. The bearing arrangement according to claim 19, wherein the tool gripping surfaces extend to the first end of the eccentric grommet.

25. The bearing arrangement according to claim 14, wherein the eccentric grommet has a continuous cylindrical peripheral area on an outer surface on one outer end.

26. The bearing arrangement according to claim 14, wherein the bearing housing is a part of a gear housing section.
